(19) United States
(12) Patent Application Publication
(10) Pub. No.: US 2012/0236121 A1
(43) Pub. Date: Sep. 20, 2012

(54) Methods of Operating a Three-Dimensional Image Sensor Including a Plurality of Depth Pixels

(76) Inventors: Yoon-Dong Park, Yongin-si (KR); Eric R. Fossum, Wolfeboro, NH (US)

(21) Appl. No.: 13/420,862

(22) Filed: Mar. 15, 2012

(30) Foreign Application Priority Data
Mar. 15, 2011 (KR) 10-2011-0022816

(51) Int. Cl. H04N 13/02

(52) U.S. Cl. 348/46; 348/E13.074

(57) ABSTRACT

In a method of operating a three-dimensional image sensor according to example embodiments, modulated light is emitted to an object of interest, the modulated light that is reflected from the object of interest is detected using a plurality of depth pixels, and a plurality of pixel group outputs respectively corresponding to a plurality of pixel groups are generated based on the detected modulated light by grouping the plurality of depth pixels into the plurality of pixel groups including a first pixel group and a second pixel group that have different sizes from each other.

### CROSS-REFERENCE TO RELATED APPLICATIONS

This U.S. non-provisional application claims the benefit of priority under 35 U.S.C. §119 to Korean Patent Application No. 10-2011-0022816 filed on Mar. 15, 2011 in the Korean Intellectual Property Office (KIPO), the entire content of which is incorporated herein by reference in its entirety.

### BACKGROUND

An image sensor is a photo-detection device that converts optical signals including image and/or distance (i.e., depth) information of an object into electrical signals. Various types of image sensors, such as charge-coupled device (CCD) image sensors, CMOS image sensors (CIS), etc., have been developed to provide high quality image information of the object. Recently, a three-dimensional (3D) image sensor is being researched and developed which provides depth information as well as two-dimensional image information.

The three-dimensional image sensor emits modulated light to the object using a light source, and may obtain the depth information by detecting the modulated light reflected from the object. In a conventional three-dimensional image sensor, power consumption may be increased if the intensity of the modulated light is increased, and a signal-to-noise ratio (SNR) may be reduced if the intensity of the modulated light is decreased.

### SUMMARY

Some example embodiments provide methods of operating a three-dimensional image sensor. Such methods may include emitting modulated light to an object of interest, detecting, at a plurality of depth pixels in the three-dimensional image sensor, reflected modulated light that is reflected from the object of interest, and generating a plurality of pixel group outputs respectively corresponding to a plurality of pixel groups based on the detected modulated light by grouping the plurality of depth pixels into a plurality of pixel group including a first pixel group and a second pixel group.

In some embodiments, the first pixel group includes a first pixel group size that corresponds to a first quantity of the plurality of depth pixels and the second pixel group includes a second pixel group size that corresponds to a second quantity of the plurality of depth pixels, and wherein the first size is different from the second size. Some embodiments provide that the first pixel group has a first distance from the center of the field of view, and the second pixel group has a second distance greater than the first distance from the center of the field of view and that a quantity of the depth pixels included in the first pixel group is smaller than a quantity of the depth pixels included in the second pixel group.

In some embodiments, generating the plurality of pixel group outputs comprises generating the plurality of pixel group outputs as a function of a location of the pixel group relative to a given portion the plurality of depth pixels. Some embodiments provide that the given portion of the plurality of depth pixels corresponds to a center of a field of view of the three-dimensional image sensor. In some embodiments, the given portion of the plurality of depth pixels corresponds to an object of interest in a field of view of the three-dimensional image sensor.

Some embodiments provide that a size of each of the plurality of pixel groups is determined according to a distance of each of the plurality of pixel groups from a center of a field of view. In some embodiments, a size of each of the plurality of pixel groups is determined according to a distance of each of the plurality of pixel groups from an object of interest in a field of view. Some embodiments provide that the first pixel group has a first distance from the object of interest in the field of view, and the second pixel group has a second distance greater than the first distance from the object of interest in the field of view. Some embodiments provide that a quantity of the depth pixels included in the first pixel group is smaller than a quantity of the depth pixels included in the second pixel group.

In some embodiments, a size of each of the plurality of pixel groups is determined such that a signal-to-noise ratio of each of the plurality of pixel group outputs is higher than a target signal-to-noise ratio. Some embodiments provide that sizes of the plurality of pixel groups are determined such that signal-to-noise ratios of different ones of the plurality of pixel group outputs are substantially the same.

Some embodiments provide that at least two of the plurality of pixel groups partially overlap each other. In some embodiments, the plurality of pixel groups includes a third pixel group including at least one of the plurality of depth pixels included in the first pixel group, and a fourth pixel group including at least one of the plurality of depth pixels included in the second pixel group. Some embodiments provide that the plurality of depth pixels are grouped into the plurality of pixel groups such that a quantity of the plurality of pixel groups is substantially the same as a quantity of the plurality of depth pixels.

Some embodiments of the present invention include methods of operating a three-dimensional image sensor including a light source module and a plurality of depth pixels, the light source module including a light source and a lens. Such methods may include emitting first modulated light to an object of interest using the light source module, detecting the first modulated light that is reflected from the object of interest using the plurality of depth pixels, obtaining position information of the object of interest based on the detected first modulated light, and adjusting a relative position of the light source to the lens based on the position information. Methods may further include emitting second modulated light to the object of interest using the light source module in which the relative position is adjusted, detecting the second modulated light that is reflected from the object of interest using the plurality of depth pixels, and generating a plurality of pixel group outputs respectively corresponding to a plurality of pixel groups based on the detected second modulated light by grouping the plurality of depth pixels into the plurality of pixel groups including a first pixel group and a second pixel group that have different sizes from each other.

In some embodiments, the relative position of the light source to the lens is adjusted such that the second modulated light is focused on the object of interest, and a size of each of the plurality of pixel groups is determined according to a distance of each of the plurality of pixel groups from the object of interest in a field of view. Some embodiments provide that the first pixel group has a first distance from the object of interest in the field of view, and the second pixel group has a second distance greater than the first distance from the object of interest in the field of view, and that a quantity of the depth pixels included in the first pixel group is smaller than a quantity of the depth pixels included in the second pixel group.

In some embodiments, the position information includes at least one of a distance of the object of interest from the three-dimensional image sensor, a horizontal position of the object of interest in a field of view, a vertical position of the object of interest in the field of view, and a size of the object of interest in the field of view.

Some embodiments provide that adjusting the relative position of the light source to the lens includes adjusting at least one of an interval between the light source and the lens, a horizontal position of the light source, a horizontal position of the lens, a vertical position of the light source, and a vertical position of the lens.

It is noted that aspects of the inventive concept described with respect to one embodiment, may be incorporated in a different embodiment although not specifically described relative thereto. That is, all embodiments and/or features of any embodiment can be combined in any way and/or combination. These and other objects and/or aspects of the present inventive concept are explained in detail in the specification set forth below.

### BRIEF DESCRIPTION OF THE DRAWINGS

The accompanying figures are included to provide a further understanding of the present inventive concept, and are incorporated in and constitute a part of this specification. The drawings illustrate some embodiments of the present inventive concept and, together with the description, serve to explain principles of the present inventive concept.

FIG. 1 is a block diagram illustrating a three-dimensional image sensor according to some embodiments of the inventive concept.

FIG. 2 is a diagram illustrating an example of a pixel array included in a three-dimensional image sensor of FIG. 1.

FIG. 3 is a flow chart illustrating a method of operating a three-dimensional image sensor according to some embodiments of the inventive concept.

FIG. 4 is a diagram for describing an example of a plurality of depth pixels that are grouped according to methods of operating a three-dimensional image sensor illustrated in FIG. 3.

FIG. 5 is a flow chart illustrating methods of operating a three-dimensional image sensor according to some embodiments of the inventive concept.

FIG. 6 is a diagram for describing an example of a plurality of depth pixels that are grouped according to methods of operating a three-dimensional image sensor illustrated in FIG. 5.

FIG. 7 is a flow chart illustrating methods of operating a three-dimensional image sensor according to some embodiments of the inventive concept.

FIG. 8 is a diagram for describing an example of a plurality of depth pixels that are grouped according to methods of operating a three-dimensional image sensor illustrated in FIG. 7.

FIG. 9 is a flow chart illustrating methods of operating a three-dimensional image sensor according to some embodiments of the inventive concept.

FIGS. 10A and 10B are diagrams for describing an example where a relative position of a light source to a lens is adjusted according to a distance of an object of interest from a three-dimensional image sensor according to some embodiments of the inventive concept.

FIG. 11 is a diagram for describing an example where a relative position of a light source to a lens is adjusted according to a horizontal position and a vertical position of an object of interest according to some embodiments of the inventive concept.

FIG. 12 is a block diagram illustrating a camera including a three-dimensional image sensor according to some embodiments of the inventive concept.

FIG. 13 is a block diagram illustrating a computing system including a three-dimensional image sensor according to some embodiments of the inventive concept.

FIG. 14 is a block diagram illustrating an example of an interface used in a computing system of FIG. 13.

### DETAILED DESCRIPTION

Various example embodiments will be described more fully hereinafter with reference to the accompanying drawings, in which some example embodiments are shown. The present inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and the present specification and will not be interpreted in an idealized or overly formal sense unless expressly so defined herein.

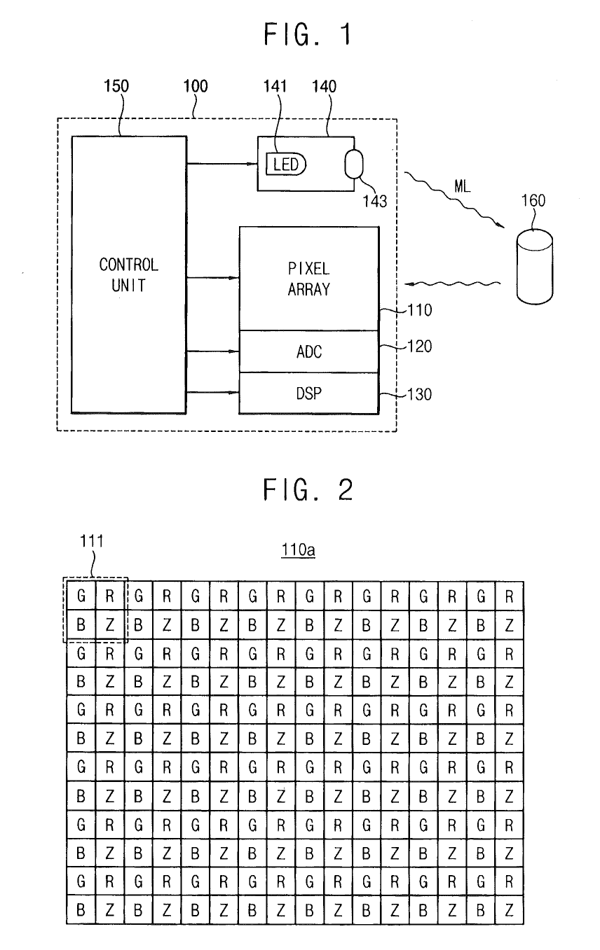

FIG. 1 is a block diagram illustrating a three-dimensional image sensor according to some embodiments of the inventive concept.

Referring to FIG. 1, a three-dimensional image sensor 100 includes a pixel array 110, an analog-to-digital conversion (ADC) unit 120, a digital signal processing (DSP) unit 130, a light source module 140 and a control unit 150.

The pixel array 110 may include depth pixels receiving modulated light ML that is reflected from an object of interest 160 after being emitted to the object of interest 160 by the light source module 140. The depth pixels may convert the received modulated light ML into electrical signals. The depth pixels may provide information about a distance of the object of interest 160 from the three-dimensional image sensor 100 (i.e. depth information) and/or black-and-white image information.

The pixel array 110 may further include color pixels for providing color image information. In this case, the three-dimensional image sensor 100 may be a three-dimensional color image sensor that provides the color image information and the depth information. According to some embodiments, an infrared filter and/or a near-infrared filter may be formed on the depth pixels, and a color filter (e.g., red, green and blue filters) may be formed on the color pixels. According to some embodiments, a ratio of the number of the depth pixels to the number of the color pixels may vary as desired.

The ADC unit 120 may convert an analog signal output from the pixel array 110 into a digital signal. In some example embodiments, the ADC unit 120 may perform a column analog-to-digital conversion that converts analog signals in parallel using a plurality of analog-to-digital converters respectively coupled to a plurality of column lines. In some example embodiments, the ADC unit 120 may perform a single analog-to-digital conversion that sequentially converts the analog signals using a single analog-to-digital converter.

According to some embodiments, the ADC unit 120 may further include a correlated double sampling (CDS) unit (not shown) for extracting an effective signal component. In some example embodiments, the CDS unit may perform an analog double sampling that extracts the effective signal component based on a difference between an analog reset signal including a reset component and an analog data signal including a signal component. In some example embodiments, the CDS unit may perform a digital double sampling that converts the analog reset signal and the analog data signal into two digital signals and extracts the effective signal component based on a difference between the two digital signals. In some example embodiments, the CDS unit may perform a dual correlated double sampling that performs both the analog double sampling and the digital double sampling.

The DSP unit 130 may receive a digital image signal output from the ADC unit 120, and may perform image data processing on the digital image signal. For example, the DSP unit 130 may perform image interpolation, color correction, white balance, gamma correction, color conversion, etc. Although FIG. 1 illustrates an example where the DSP unit 130 is included in the three-dimensional image sensor 100, according to example embodiments, the DSP unit 130 may be located outside the three-dimensional image sensor 100.

The DSP unit 130 may generate pixel group outputs based on outputs of the depth pixels included in the pixel array 110. For example, the DSP unit 130 may generate the pixel group outputs respectively corresponding to pixel groups by grouping the depth pixels into the pixel groups. Accordingly, since outputs of the pixel groups each may include outputs corresponding to at least one depth pixel, a signal-to-noise ratio (SNR) of an output from the three-dimensional image sensor 100 may be improved.

The light source module 140 may emit the modulated light ML of a desired (or, alternatively predetermined) wavelength. For example, the light source module 140 may emit modulated infrared light and/or modulated near-infrared light. The light source module 140 may include a light source 141 and a lens 143. The light source 141 may be controlled by the control unit 150 to emit the modulated light ML such that the modulated light ML is modulated to have substantially periodic intensity. For example, the intensity of the modulated light ML may be modulated to have a waveform of a pulse wave, a sine wave, a cosine wave, or the like. The light source 141 may be implemented by a light emitting diode (LED), a laser diode, or the like. The lens 143 may focus the modulated light ML emitted by the light source 141 on the object of interest 160. In some example embodiments, the lens 143 may be configured to adjust an emission angle of the modulated light ML output from the light source 141. For example, an interval or distance between the light source 141 and the lens 143 may be controlled by the control unit 150 to adjust the emission angle of the modulated light ML.

The control unit 150 may control the pixel array 110, the ADC unit 120, the DSP unit 130 and the light source module 140. The control unit 150 may provide the pixel array 110, the ADC unit 120, the DSP unit 130 and the light source module 140 with control signals, such as a clock signal, a timing control signal, or the like. According to some embodiments, the control unit 150 may include a control logic circuit, a phase locked loop circuit, a timing control circuit, a communication interface circuit, or the like.

Although not illustrated in FIG. 1, according to some embodiments, the three-dimensional image sensor 100 may further include a row decoder that selects a row line of the pixel array 110, and a row driver that activates the selected row line. According to some embodiments, the three-dimensional image sensor 100 may further include a column decoder that selects one of a plurality of analog-to-digital converters included in the ADC unit 120, and a column driver that provides an output of the selected analog-to-digital converter to the DSP unit 130 or an external host (not shown).

Hereinafter, an operation of the three-dimensional image sensor 100 according to some embodiments will be described below.

The control unit 150 may control the light source module 140 to emit the modulated light ML having the periodic intensity. The modulated light ML emitted by the light source module 140 may be reflected from the object of interest 160 back to the three-dimensional image sensor 100, and may be incident on the depth pixels. The depth pixels may output analog signals corresponding to the incident modulated light ML. The ADC unit 120 may convert the analog signals output from the depth pixels into digital signals. The DSP unit 130 may generate pixel group outputs based on the digital signals, and may provide the pixel group outputs to the external host.

In some example embodiments, the DSP unit 130 may generate the pixel group outputs respectively corresponding to the pixel groups by grouping the depth pixels into the pixel groups such that sizes of the pixel groups are determined according to distances of the pixel groups from the center of a field of view (FOV). For example, the DSP unit 130 may group the depth pixels into the pixel groups such that the number of depth pixels included in each pixel group increases as the distance of each pixel group from the center of the FOV increases.

The modulated light ML emitted by the light source 141 may be substantially focused on a center region of the FOV, and the modulated light ML may be projected onto a peripheral region of the FOV with relatively low intensity. In the three-dimensional image sensor 100 according to some embodiments, since each pixel group located at the center region of the FOV includes the relatively small number of depth pixels, high resolution may be obtained with respect to the pixel groups located at the center region. Further, in the three-dimensional image sensor 100 according to example embodiments, since each pixel group located at the peripheral region of the FOV includes the relatively large number of depth pixels, the SNR may be improved with respect to the pixel groups located at the peripheral region although the intensity of the modulated light ML is low at the peripheral region of the FOV. Accordingly, since the SNR of the pixel group outputs are maintained without increasing the intensity of the modulated light ML, the three-dimensional image sensor 100 according to some embodiments may reduce power consumption.

In some example embodiments, the DSP unit 130 may generate the pixel group outputs respectively corresponding to the pixel groups by grouping the depth pixels into the pixel groups such that sizes of the pixel groups are determined according to distances of the pixel groups from the object of interest 160. For example, the DSP unit 130 may group the depth pixels into the pixel groups such that the number of depth pixels included in each pixel group increases as the distance of each pixel group from the object of interest 160 increases.

The modulated light ML may be substantially focused on the object of interest 160. In some example embodiments, each pixel group located near the object of interest 160 in the FOV may include the relatively small number of depth pixels, and high resolution may be obtained with respect to the pixel groups located near the object of interest 160 in the FOV. Further, each pixel group located far from the object of interest 160 in the FOV may include the relatively large number of depth pixels, the SNR may be improved with respect to the pixel groups located far from the object of interest 160 in the FOV although the intensity of the modulated light ML is low. Accordingly, the power consumption may be reduced while maintaining the SNR throughout the FOV.

According to some embodiments, the pixel groups may overlap each other. That is, one depth pixel may be shared by at least two pixel groups. In some example embodiments, the depth pixels may be grouped into overlapping pixel groups such that the number of the pixel groups is substantially the same as the number of the depth pixels. In this case, each depth pixel may correspond to one pixel group having a size determined according to a position in the FOV.

As described above, in the three-dimensional image sensor 100 according to some embodiments, since the depth pixels are grouped into the pixel groups having sizes determined according to distances from the center of the FOV or from the object of interest 160 in the FOV, depth information with high resolution may be obtained near the center of the FOV or the object of interest 160. Further, in the three-dimensional image sensor 100 according to some embodiments, although the modulated light ML may be projected with low intensity onto a region far from the center or the object of interest 160 in the FOV, the SNR of the pixel group outputs may be improved since the pixel groups far from the center or the object of interest 160 have large sizes. Accordingly, the power consumption of the three-dimensional image sensor 100 may be reduced while maintaining the SNR.

FIG. 2 is a diagram illustrating an example of a pixel array included in a three-dimensional image sensor of FIG. 1.

Referring to FIG. 2, a pixel array 110a may include a pixel pattern 111 having color pixels R, G and B providing color image information and a depth pixel Z providing depth information. The pixel pattern 111 may be repeatedly arranged in the pixel array 110a. For example, the color pixels R, G and B may include a red pixel R, a green pixel G and a blue pixel B. According to some embodiments, each of the color pixels R, G and B and the depth pixel Z may include a photodiode, a photo-transistor, a photo-gate, a pinned photo diode (PPD) and/or a combination thereof.

According to some embodiments, color filters may be formed on the color pixels R, G and B, and an infrared filter (or a near-infrared filter) may be formed on the depth pixel Z. For example, a red filter may be formed on the red pixel R, a green filter may be formed on the green pixel G, a blue filter may be formed on the blue pixel B, and an infrared (or near-infrared) pass filter may be formed on the depth pixel Z. In some example embodiments, an infrared (or near-infrared) cut filter may be further formed on the color pixels R, G and B.

Although FIG. 2 illustrates the RGBZ pixel array 110a including the color pixels R, G and B and the depth pixel Z, in some example embodiments, a pixel array may include only the depth pixels Z. In some example embodiments, a three-dimensional image sensor may include a color pixel array including the color pixels R, G and B, and a depth pixel array including the depth pixels Z.

Although FIG. 2 illustrates the depth pixel Z having a size substantially the same size as that of each color pixel R, G and B, which may be referred to as a “small Z pixel”, according to example embodiments, the size of the depth pixel Z may be different from the size of each color pixel R, G and B. For example, the pixel array 110a may include a depth pixel having a size larger than that of the each color pixel R, G and B, which may be referred to as a “large Z pixel”. Further, according to some embodiments, the pixel array 110a may include various pixel patterns.

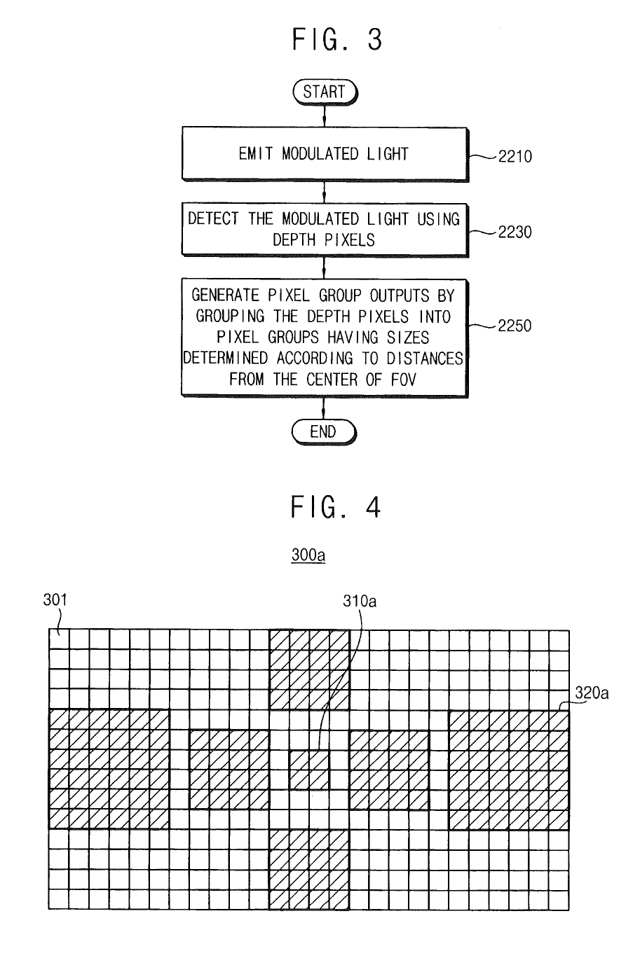

FIG. 3 is a flow chart illustrating methods of operating a three-dimensional image sensor according to some embodiments.

Referring to FIGS. 1 and 3, a control unit 150 may control a light source module 140 to emit modulated light ML (block 2210). The modulated light ML may be modulated such that the intensity of the modulated light ML periodically changes. The modulated light ML may be reflected from an object of interest 160, and may be incident on a plurality of depth pixels included in a pixel array 110.

A three-dimensional image sensor 100 may detect the modulated light ML incident on the plurality of depth pixels using the plurality of depth pixels (block 2230). The modulated light ML incident on the plurality of depth pixels may generate an electron-hole pair, and the plurality of depth pixels may accumulate an electron of the electron-hole pair to generate an electrical signal corresponding to the modulated light ML. An ADC unit 120 may convert an analog signal output from the plurality of depth pixels into a digital signal.

To provide depth information based on the detected modulated light ML, a DSP unit 130 may generate a plurality of pixel group outputs corresponding to a plurality of pixel groups by grouping the plurality of depth pixels into the plurality of pixel groups having sizes determined according to distances from the center of the FOV of the three-dimensional image sensor 100 (block 2250). The DSP unit 130 may group the plurality of depth pixels such that the number of depth pixels included in each pixel group increases as the distance of each pixel group from the center of the FOV increases.

For example, the plurality of pixel groups may include a first pixel group having a first distance from the center of the FOV, and a second pixel group having a second distance greater than the first distance from the center of the FOV. In this case, the number of the depth pixels included in the first pixel group may be smaller than the number of the depth pixels included in the second pixel group. The modulated light ML emitted by a light source 141 may be substantially focused on a center region of the FOV, and the modulated light ML may be projected onto a peripheral region of the FOV with relatively low intensity. Each pixel group located at the center region may include the relatively small number of depth pixels, and thus high resolution and a high SNR may be obtained at the center region. Further, each pixel group located at the peripheral region may include the relatively large number of depth pixels, and thus the SNR may not be deteriorated at the peripheral region although the intensity of the modulated light ML is low.

According to some embodiments, sizes of the plurality of pixel groups may be determined such that SNRs of the plurality of pixel group outputs are higher than a target SNR. For example, since the modulated light ML is projected onto the peripheral region of the FOV with relatively low intensity, the pixel groups located at the peripheral region may include the relatively large number of depth pixels to increase the SNR. Accordingly, the SNRs of the plurality of pixel group outputs may be maintained greater than the target SNR throughout the FOV. In some example embodiments, the sizes of the plurality of pixel groups may be determined such that the SNRs of the plurality of pixel groups are substantially the same.

As described above, in methods of operating the three-dimensional image sensor 100 according to some embodiments, since the plurality of depth pixels are grouped into the plurality of pixel groups having sizes determined according to the distances from the center of the FOV, depth information with high resolution may be obtained at the center region, and depth information with improved SNR may be obtained at the peripheral region. Further, in methods of operating the three-dimensional image sensor 100 according to some embodiments, the SNRs of the pixel group outputs may be maintained greater than the target SNR without increasing the intensity of the modulated light ML, thereby reducing the power consumption.

FIG. 4 is a diagram for describing an example of a plurality of depth pixels that are grouped according to methods of operating a three-dimensional image sensor illustrated in FIG. 3.

FIG. 4 illustrates a FOV 300a that is divided into a plurality of regions 301. Each region 301 illustrated in FIG. 4 may correspond to one depth pixel included in a pixel array. A plurality of depth pixels may be grouped into a plurality of pixel groups 310a and 320a having sizes determined according to distances from the center of the FOV 300a. As illustrated in FIG. 4, the plurality of depth pixels may be grouped such that the number of the depth pixels included in each pixel group 310a and 320a increases as the distance from the center of the FOV 300a increases.

For example, a first pixel group 310a located at the center of the FOV 300a may include the relatively small number of the depth pixels (e.g., four depth pixels), and a second pixel group 320a located far from the center of the FOV 300a may include relatively large number of the depth pixels (e.g., thirty-six depth pixels). Accordingly, depth information may have high resolution at a center region of the FOV 300a, and may have an improved SNR at a peripheral region of the FOV 300a.

Although FIG. 4 illustrates seven pixel groups for convenience of illustration, according to some embodiments, the plurality of depth pixels may be grouped into various numbers of the pixel groups including more or less than seven pixel groups. Although FIG. 4 illustrates three hundred and sixty-four depth pixels for convenience of illustration, according to some embodiments, the pixel array may include various number of the depth pixels including more or less than three hundred and sixty-four depth pixels. In addition, the pixel array may further include color pixels corresponding to the FOV 300a.

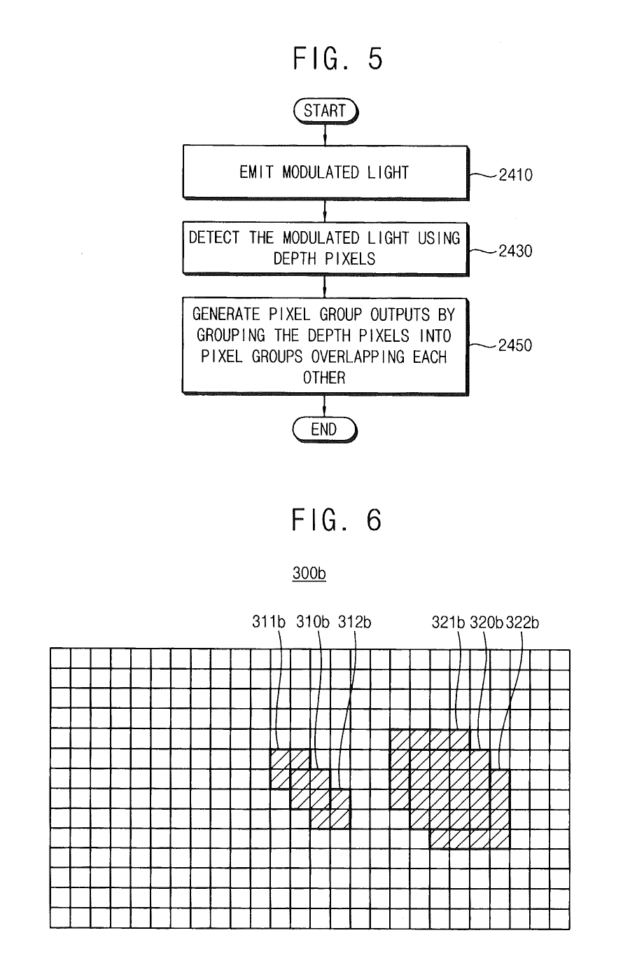

FIG. 5 is a flow chart illustrating methods of operating a three-dimensional image sensor according to some embodiments.

Referring to FIGS. 1 and 5, a control unit 150 may control a light source module 140 to emit modulated light ML (block 2410). A three-dimensional image sensor 100 may detect the modulated light ML that is reflected from an object of interest 160 to a plurality of depth pixels using the plurality of depth pixels (block 2430).

To provide depth information based on the detected modulated light ML, a DSP unit 130 may generate a plurality of pixel group outputs corresponding to a plurality of pixel groups by grouping the plurality of depth pixels into the plurality of pixel groups at least partially overlapping each other (block 2450). Further, the DSP unit 130 may group the plurality of depth pixels such that the number of depth pixels included in each pixel group increases as the distance of each pixel group from the center of a FOV increases.

For example, the plurality of pixel groups may include first pixel groups overlapping each other at a center region of the FOV, and a second pixel groups overlapping each other at a peripheral region of the FOV. That is, the first pixel groups may share one or more depth pixels located at the center region of the FOV, and the second pixel groups may share one or more depth pixels located at the peripheral region of the FOV. According to some embodiments, the first pixel groups may have substantially the same size as each other, the second pixel groups may have substantially the same size as each other, and the size of the first pixel groups located at the center region may be smaller than the size of the second pixel groups located at the peripheral region.

In some example embodiments, the plurality of depth pixels may be grouped such that the number of depth pixels included in each pixel group increases as the distance of each pixel group from the object of interest 160 in the FOV increases. In such embodiments, the pixel groups located near the object of interest 160 in the FOV may have a small size relative to the pixel groups having a greater distance from the center of the FOV and/or from the object of interest 160 in the FOV.

In some example embodiments, the plurality of depth pixels may be grouped into the plurality of pixel groups such that the number of the pixel groups is substantially the same as the number of the depth pixels. That is, each depth pixel may correspond to one pixel group having a size determined according to a position in the FOV.

As described above, in methods of operating the three-dimensional image sensor 100 according to some embodiments, since the plurality of depth pixels are grouped into the plurality of pixel groups that overlap each other, depth information with high resolution may be provided.

FIG. 6 is a diagram for describing an example of a plurality of depth pixels that are grouped according to methods of operating a three-dimensional image sensor illustrated in FIG. 5.

FIG. 6 illustrates a FOV 300b that is divided into a plurality of regions. Each region illustrated in FIG. 6 may correspond to one depth pixel included in a pixel array. A plurality of depth pixels may be grouped into a plurality of pixel groups 310b, 311b, 312b, 320b, 321b and 322b that overlap each other. According to some embodiments, sizes of the plurality of pixel groups 310b, 311b, 312b, 320b, 321b and 322b may be determined according to distances from the center of the FOV 300b or from an object of interest in the FOV 300b. For example, as illustrated in FIG. 6, the plurality of depth pixels may be grouped such that the number of the depth pixels included in each pixel group 310b, 311b, 312b, 320b, 321b and 322b increases as the distance from the center of the FOV 300b increases.

For example, first through third pixel groups 310b, 311b and 312b located at a center region of the FOV 300b may overlap each other, and fourth through sixth pixel groups 320b, 321b and 322b located at a peripheral region of the FOV 300b may overlap each other. Further, each of the first through third pixel groups 310b, 311b and 312b may include the relatively small number of the depth pixels (e.g., four depth pixels), and each of the fourth through sixth pixel groups 320b, 321b and 322b may include relatively large number of the depth pixels (e.g., sixteen depth pixels). Accordingly, since the plurality of depth pixels are grouped into the plurality of pixel groups 310b, 311b, 312b, 320b, 321b and 322b that overlap each other, depth information with high resolution may be provided.

Although FIG. 6 illustrates six pixel groups for convenience of illustration, according to some embodiments, the plurality of depth pixels may be grouped into various numbers of the pixel groups.

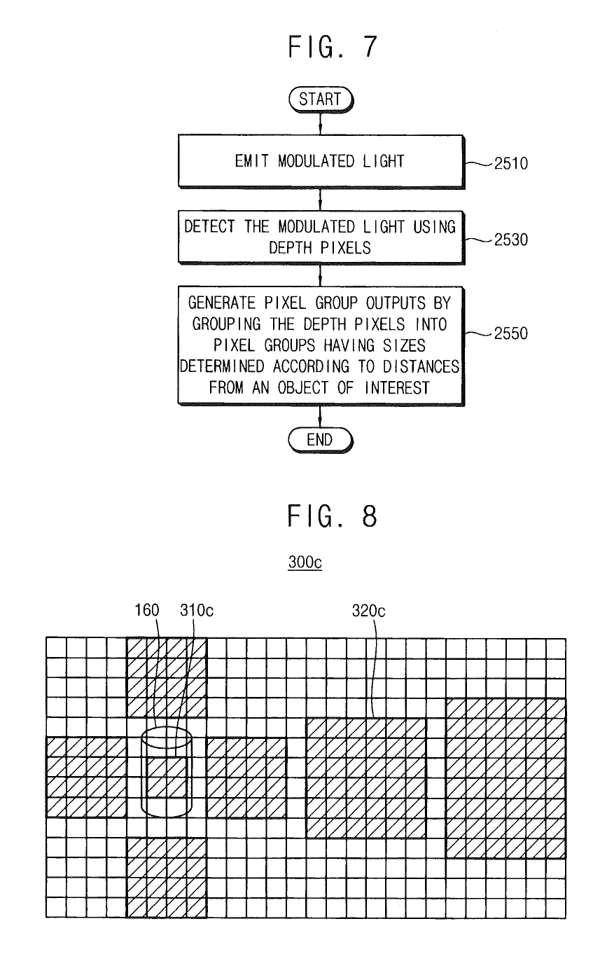

FIG. 7 is a flow chart illustrating methods of operating a three-dimensional image sensor according to some example embodiments.

Referring to FIGS. 1 and 7, a control unit 150 may control a light source module 140 to emit modulated light ML (block 2510). A three-dimensional image sensor 100 may detect the modulated light ML that is reflected from an object of interest 160 to a plurality of depth pixels using the plurality of depth pixels (block 2530).

To provide depth information based on the detected modulated light ML, a DSP unit 130 may generate a plurality of pixel group outputs corresponding to a plurality of pixel groups by grouping the plurality of depth pixels into the plurality of pixel groups having sizes determined according to distances from the object of interest 160 in a FOV (block 2550). The DSP unit 130 may group the plurality of depth pixels such that the number of depth pixels included in each pixel group increases as the distance of each pixel group from the object of interest 160 in the FOV increases.

For example, the plurality of pixel groups may include a first pixel group having a first distance from the object of interest 160 in the FOV and a second pixel group having a second distance greater than the first distance from the object of interest 160 in the FOV, and the number of the depth pixels included in the first pixel group may be smaller than the number of the depth pixels included in the second pixel group. The modulated light ML emitted by a light source 141 may be substantially focused on the object of interest 160, and the modulated light ML may be projected onto a region far from the object of interest 160 with relatively low intensity. Each pixel group located near the object of interest 160 may include the relatively small number of depth pixels, and thus high resolution and a high SNR may be obtained at a region near the object of interest 160. Further, each pixel group located far from the object of interest 160 may include the relatively large number of depth pixels, and thus the SNR may not be deteriorated at a region far from the object of interest 160 although the intensity of the modulated light ML is low.

According to some embodiments, sizes of the plurality of pixel groups may be determined such that SNRs of the plurality of pixel group outputs are higher than a target SNR. For example, since the modulated light ML is projected onto the region far from the object of interest 160 with relatively low intensity, the pixel groups located at the region far from the object of interest 160 may include the relatively large number of depth pixels to increase the SNR. Accordingly, the SNRs of the plurality of pixel group outputs may be maintained greater than the target SNR throughout the FOV. In some example embodiments, the sizes of the plurality of pixel groups may be determined such that the SNRs of the plurality of pixel groups are substantially the same.

As described above, in methods of operating the three-dimensional image sensor 100 according to some embodiments, since the plurality of depth pixels are grouped into the plurality of pixel groups having sizes determined according to the distances from the object of interest 160, depth information with high resolution may be obtained at the region near the object of interest 160, and depth information with improved SNR may be obtained at the region far from the object of interest 160. Further, in methods of operating the three-dimensional image sensor 100 according to some embodiments, the SNRs of the pixel group outputs may be maintained greater than the target SNR without increasing the intensity of the modulated light ML, thereby reducing the power consumption.

FIG. 8 is a diagram for describing an example of a plurality of depth pixels that are grouped according to methods of operating a three-dimensional image sensor illustrated in FIG. 7.

FIG. 8 illustrates a FOV 300c that is divided into a plurality of regions. Each region illustrated in FIG. 8 may correspond to one depth pixel included in a pixel array. A plurality of depth pixels may be grouped into a plurality of pixel groups 310c and 320c having sizes determined according to distances from an object of interest 160 in the FOV 300c. As illustrated in FIG. 8, the plurality of depth pixels may be grouped such that the number of the depth pixels included in each pixel group 310c and 320c increases as the distance from the object of interest 160 in the FOV 300c increases.

For example, a first pixel group 310c located near the object of interest 160 in the FOV 300c may include the relatively small number of the depth pixels (e.g., four depth pixels), and a second pixel group 320c located far from the object of interest 160 in the FOV 300c may include relatively large number of the depth pixels (e.g., thirty-six depth pixels). Accordingly, depth information may have high resolution at a region near the object of interest 160, and may have an improved SNR at a region far from the object of interest 160.

Although FIG. 8 illustrates seven pixel groups for convenience of illustration, according to some embodiments, the plurality of depth pixels may be grouped into various numbers of the pixel groups.

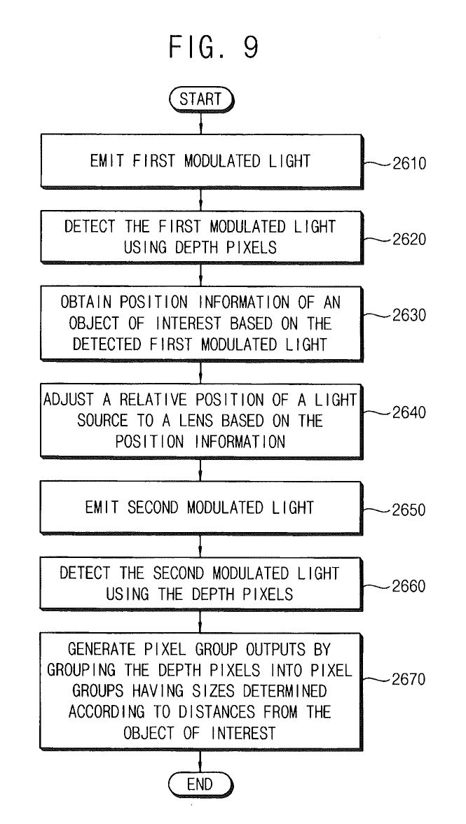

FIG. 9 is a flow chart illustrating methods of operating a three-dimensional image sensor according to some embodiments.

Referring to FIGS. 1 and 9, a control unit 150 may control a light source module 140 to emit first modulated light ML (block 2610). A three-dimensional image sensor 100 may detect the first modulated light ML that is reflected from an object of interest 160 to a plurality of depth pixels using the plurality of depth pixels (block 2620).

A DSP unit 130 may obtain position information of the object of interest 160 based on the detected first modulated light ML (block 2630). According to some embodiments, the position information may include at least one of a distance of the object of interest 160 from the three-dimensional image sensor 100, a horizontal position of the object of interest 160 in a FOV, a vertical position of the object of interest 160 in the FOV, and a size of the object of interest 160 in the FOV.

To focus the modulated light ML on the object of interest 160, the control unit 150 may control the light source module 140 to adjust a relative position of a light source 141 to a lens 143 based on the position information (block 2640). According to some embodiments, the control unit 150 may adjust at least one of an interval between the light source 141 and the lens 143, a refractive index of the lens 143, a curvature of the lens 143, a horizontal position of the light source 141, a horizontal position of the lens 143, a vertical position of the light source 141 and/or a vertical position of the lens 143, among others.

After the relative position of the light source 141 to the lens 143 is adjusted based on the position information, the control unit 150 may control the light source module 140 to emit second modulated light ML (block 2650). The three-dimensional image sensor 100 may detect the second modulated light ML that is reflected from the object of interest 160 to the plurality of depth pixels using the plurality of depth pixels (block 2660).

To provide depth information based on the detected second modulated light ML, the DSP unit 130 may generate a plurality of pixel group outputs corresponding to a plurality of pixel groups by grouping the plurality of depth pixels into the plurality of pixel groups having sizes determined according to distances from the object of interest 160 in the FOV (block 2670). As described above, the light source module 140 may focus the second modulated light ML on the object of interest 160 by adjusting the relative position, and the second modulated light ML may be projected onto a region far from the object of interest 160 with relatively low intensity. Thus, each pixel group located near the object of interest 160 may include the relatively small number of depth pixels, and thus high resolution and a high SNR may be obtained at a region near the object of interest 160. Further, each pixel group located far from the object of interest 160 may include the relatively large number of depth pixels, and thus the SNR may not be deteriorated at a region far from the object of interest 160 although the intensity of the modulated light ML is low.

As described above, in methods of operating the three-dimensional image sensor 100 according to example embodiments, the modulated light ML may be focused on the object of interest 160 by adjusting the relative position of the light source 141 to the lens 143, and the plurality of depth pixels may be grouped into the plurality of pixel groups having sizes determined according to the distances from the object of interest 160 in the FOV. Accordingly, depth information with high resolution may be obtained at the region near the object of interest 160, and depth information with improved SNR may be obtained at the region far from the object of interest 160. Further, the power consumption of the three-dimensional image sensor 100 may be reduced.

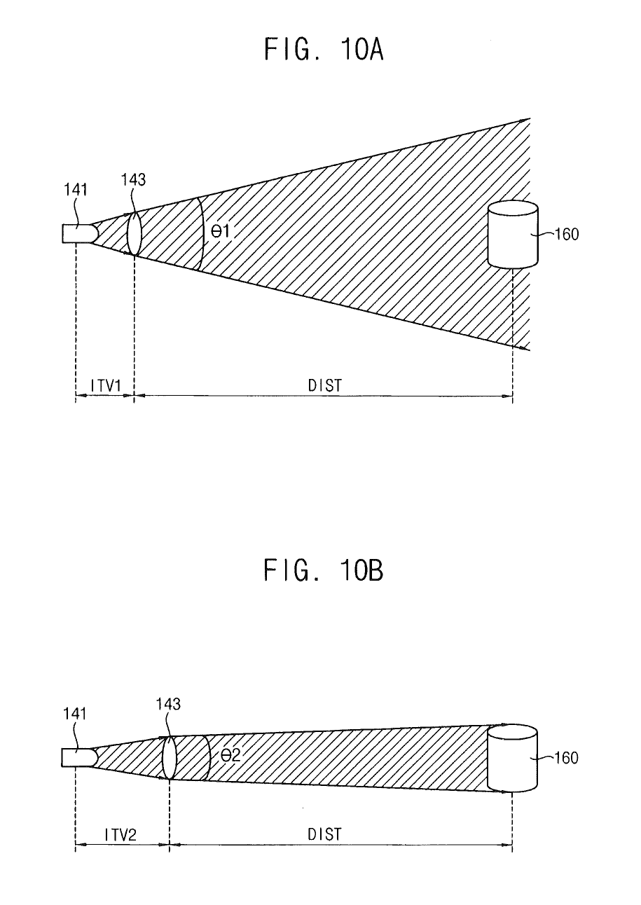

FIGS. 10A and 10B are diagrams for describing an example where a relative position of a light source to a lens is adjusted according to a distance of an object of interest from a three-dimensional image sensor according to some embodiments.

Referring to FIGS. 1 and 10A, a three-dimensional image sensor 100 may measure a distance DIST of an object of interest 160 from the three-dimensional image sensor 100 using modulated light ML emitted by a light source module 140. If a light source 141 and a lens 143 have a first interval ITV1, the modulated light ML may have a first emission angle θ1. In some example embodiments, the first emission angle θ1 may be the maximum emission angle of the modulated light ML emitted by the light source module 140. The three-dimensional image sensor 100 may measure the distance DIST of the object of interest 160 from the three-dimensional image sensor 100 by detecting the modulated light ML that is reflected from the object of interest 160.

Referring to FIGS. 1 and 10B, the three-dimensional image sensor 100 may adjust the emission angle of the modulated light ML emitted by the light source module 140 based on the distance DIST of the object of interest 160 from the three-dimensional image sensor 100. In some example embodiments, as illustrated in FIG. 10B, the three-dimensional image sensor 100 may adjust the interval between (or, the separation) the light source 141 and the lens 143 to a second interval ITV2 so that the modulated light ML emitted by the light source module 140 has a second emission angle θ2. For example, a control unit 150 may control the light source module 140 to decrease the emission angle of the modulated light ML as the distance DIST of the object of interest 160 from the three-dimensional image sensor 100 increases. According to some embodiments, the control unit 150 may move the light source 141 such that the interval between the light source 141 and the lens 143 increases as the distance DIST of the object of interest 160 from the three-dimensional image sensor 100 increases. According to some embodiments, the control unit 150 may move the lens 143 such that the interval between the light source 141 and the lens 143 increases as the distance DIST of the object of interest 160 from the three-dimensional image sensor 100 increases.

According to some embodiments, the three-dimensional image sensor 100 may adjust a curvature of the lens 143 so that the modulated light ML emitted by the light source module 140 has the second emission angle θ2. For example, the control unit 150 may increase the curvature of the lens 143 (i.e. decrease a radius of curvature of the lens 143) as the distance DIST of the object of interest 160 from the three-dimensional image sensor 100 increases.

According to some embodiments, the three-dimensional image sensor 100 may adjust a refractive index of the lens 143 so that the modulated light ML emitted by the light source module 140 has the second emission angle θ2. For example, the control unit 150 may increase the refractive index of the lens 143 as the distance DIST of the object of interest 160 from the three-dimensional image sensor 100 increases. According to some embodiments, the three-dimensional image sensor 100 may adjust any one, two or all of the interval between the light source 141 and lens 143, the curvature of the lens 143, and the refractive index of the lens 143.

In methods of operating the three-dimensional image sensor 100 according to some embodiments, since the emission angle of the modulated light ML emitted by the light source module 140 is adjusted corresponding to the distance DIST of the object of interest 160 from the three-dimensional image sensor 100, light energy projected on the object of interest 160 may be increased even with less power consumption, and the accuracy of depth information obtained by the three-dimensional image sensor 100 may be improved.

Further, in some example embodiments, the three-dimensional image sensor 100 may emit the modulated light ML with the maximum amplitude before adjusting the emission angle of the modulated light ML, and may decrease the amplitude of the modulated light ML according to a decrement of the emission angle of the modulated light ML. Accordingly, the power consumed by the light source module 140 may be reduced. However, an operation, wherein light is initially emitted with minimum amplitude and the amplitude is later maximized depending on the emission angle of modulated light ML, is also possible.

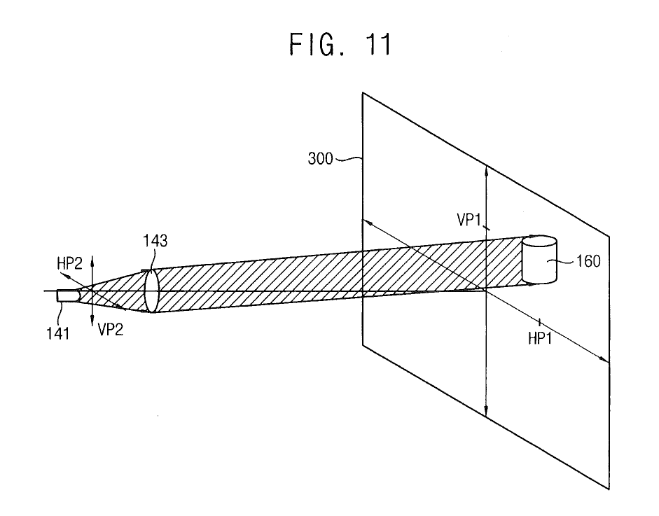

FIG. 11 is a diagram for describing an example where a relative position of a light source to a lens is adjusted according to a horizontal position and a vertical position of an object of interest according to some embodiments.

Referring to FIGS. 1 and 11, a three-dimensional image sensor 100 may measure a horizontal position HP1 and/or a vertical position VP1 of an object of interest 160 in a FOV 300 using modulated light ML emitted by a light source module 140. For example, the object of interest 160 may be placed at a distance HP1 in a positive horizontal direction and/or a distance VP1 in a positive vertical direction with respect to an imaginary line connecting the center of a light source 141 and the center of a lens 143. This straight line may be assumed to pass vertically through the plane of the paper (corresponding to the FOV 300) and through the point of intersection of the horizontal and vertical axes shown in FIG. 11.

The three-dimensional image sensor 100 may adjust a relative position (or, the placement) of the light source 141 to the lens 143 based on the horizontal position HP1 and/or the vertical position VP1 of the object of interest 160 in the FOV. In some example embodiments, as illustrated in FIG. 11, a control unit 150 may move the light source 141 by a desired (or, alternatively predetermined) distance HP2 in a negative horizontal direction and/or by a desired (or, alternatively predetermined) distance VP2 in a negative vertical direction based on the positive horizontal position HP1 and/or the positive vertical position VP1 of the object of interest 160. For example, a ratio of the adjusted horizontal position HP2 of the light source 141 to the measured horizontal position HP1 of the object of interest 160 may correspond to a ratio of a distance of the light source 141 from the lens 143 to a distance of the object of interest 160 from the lens 143, and a ratio of the adjusted vertical position VP2 of the light source 141 to the measured vertical position VP1 of the object of interest 160 may correspond to the ratio of the distance of the light source 141 from the lens 143 to the distance of the object of interest 160 from the lens 143.

In some embodiments, the control unit 150 may move the lens 143 by a desired (or, alternatively predetermined) distance in a positive horizontal direction and/or by a desired (or, alternatively predetermined) distance VP2 in a positive vertical direction based on the positive horizontal position HP1 and/or the positive vertical position VP1 of the object of interest 160.

According to some embodiments, the control unit 150 may move the light source 141 or the lens 143 in a horizontal direction and/or a vertical direction based on the horizontal position HP1 and/or the vertical position VP1 of the object of interest 160 so that the light source 141, the lens 143 and the object of interest 160 are positioned in a straight line.

Further, the control unit 150 may adjust an emission angle of the modulated light ML emitted by the light source module 140 according to a distance of the object of interest 160 from the three-dimensional image sensor 100 and/or a size of the object of interest 160 in the FOV 300, and may adjust (for example, decrease) an amplitude of the modulated light ML.

As illustrated in FIGS. 10A through 11, the relative position of the light source 141 to the lens 143 may be adjusted based on the distance of the object of interest 160 from the three-dimensional image sensor 100, the horizontal position and/or the vertical position of the object of interest 160 in the FOV 300, the size of the object of interest 160 in the FOV 300, etc., and thus light energy projected on the object of interest 160 may be increased even with less power consumption. Accordingly, the accuracy of depth information obtained by the three-dimensional image sensor 100 may be improved, and the power consumed by the light source module 140 may be reduced.

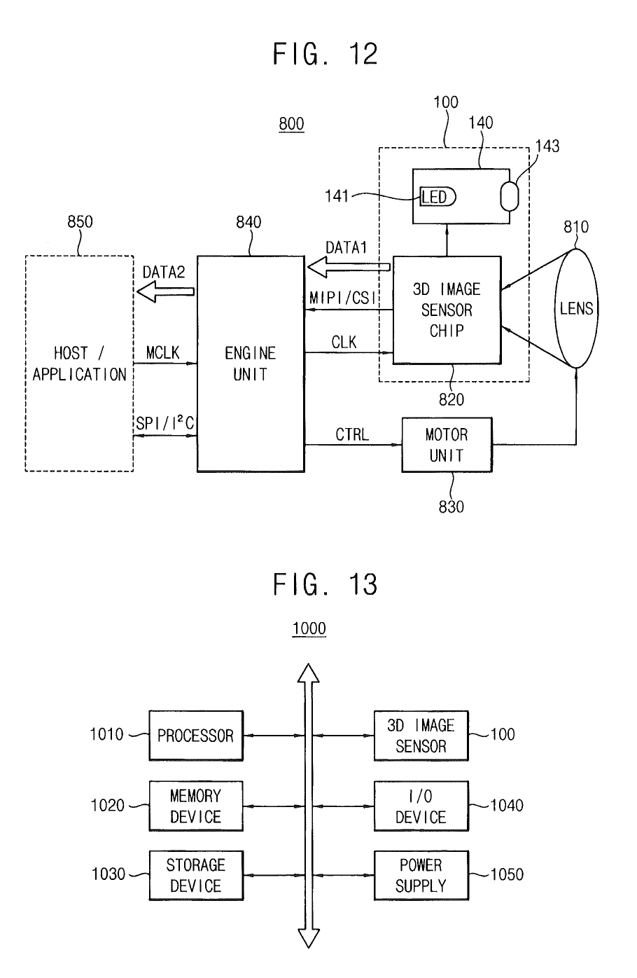

FIG. 12 is a block diagram illustrating a camera including a three-dimensional image sensor according to some embodiments.

Referring to FIG. 12, a camera 800 includes a receiving lens 810, a three-dimensional image sensor 100, a motor unit 830 and an engine unit 840. The three-dimensional image sensor 100 may include a three-dimensional image sensor chip 820 and a light source module 140. In some embodiments, the three-dimensional image sensor chip 820 and the light source module 140 may be implemented as separate devices, or may be implemented such that at least one component of the light source module 140 is included in the three-dimensional image sensor chip 820.

The receiving lens 810 may focus incident light on a photo-receiving region (e.g., depth pixels and/or color pixels) of the three-dimensional image sensor chip 820. The three-dimensional image sensor chip 820 may generate data DATA1 including depth information and/or color image information based on the incident light passing through the receiving lens 810. For example, the data DATA1 generated by the three-dimensional image sensor chip 820 may include depth data generated using infrared light or near-infrared light emitted by the light source module 140, and RGB data of a Bayer pattern generated using external visible light. The depth data may include a plurality of pixel group outputs generated by grouping a plurality of depth pixels into a plurality of pixel groups having sizes determined according to distances from the center of a FOV or from an object of interest. Accordingly, the depth data of the three-dimensional image sensor chip 820 according to example embodiments may have high resolution at a center region or an interest region while maintaining a SNR with less power consumption.

The three-dimensional image sensor chip 820 may provide the data DATA1 to the engine unit 840 in response to a clock signal CLK. According to some embodiments, the three-dimensional image sensor chip 820 may interface with the engine unit 840 using a mobile industry processor interface (MIPI) and/or a camera serial interface (CSI).

The motor unit 830 may control the focusing of the lens 810 or may perform shuttering in response to a control signal CTRL received from the engine unit 840. According to some embodiments, a relative position of a light source 141 and a lens 143 included in the light source module 140 may be adjusted by the motor unit 830 and/or the three-dimensional image sensor chip 820.

The engine unit 840 may control the three-dimensional image sensor 100 and the motor unit 830. The engine unit 840 may process the data DATA1 received from the three-dimensional image sensor chip 820. For example, the engine unit 840 may generate three-dimensional color data based on the received data DATA1. According to some embodiments, the engine unit 840 may generate YUV data including a luminance component, a difference between the luminance component and a blue component, and a difference between the luminance component and a red component based on the RGB data, and/or may generate compressed data, such as joint photography experts group (JPEG) data, among others. The engine unit 840 may be coupled to a host/application 850, and may provide data DATA2 to the host/application 850 based on a master clock signal MCLK. According to some embodiments, the engine unit 840 may interface with the host/application 850 using a serial peripheral interface (SPI) and/or an inter integrated circuit (I2C) interface, among others.

FIG. 13 is a block diagram illustrating a computing system including a three-dimensional image sensor according to some embodiments.

Referring to FIG. 13, a computing system 1000 includes a processor 1010, a memory device 1020, a storage device 1030, an input/output device 1040, a power supply 1050 and a three-dimensional image sensor 100. Although not illustrated in FIG. 13, the computing system 1000 may further include a port for communicating with electronic devices, such as a video card, a sound card, a memory card, and/or a USB device, among others.

The processor 1010 may perform specific calculations and/or tasks. For example, the processor 1010 may be a microprocessor, a central process unit (CPU), a digital signal processor, or the like. The processor 1010 may communicate with the memory device 1020, the storage device 1030 and the input/output device 1040 via an address bus, a control bus and/or a data bus, among others. The processor 1010 may be coupled to an extension bus, such as a peripheral component interconnect (PCI) bus. The memory device 1020 may store data for operating the computing system 1020. For example, the memory device 1020 may be implemented by a dynamic random access memory (DRAM), a mobile DRAM, a static random access memory (SRAM), a phase change random access memory (PRAM), a resistance random access memory (RRAM), a nano floating gate memory (NFGM), a polymer random access memory (PoRAM), a magnetic random access memory (MRAM), and/or a ferroelectric random access memory (FRAM), among others. The storage device 1030 may include a solid state drive, a hard disk drive, a CD-ROM, or the like. The input/output device 1040 may include an input device, such as a keyboard, a mouse, a keypad, etc., and an output device, such as a printer, a display device, or the like. The power supply 1050 may supply power to the computing device 1000.

The three-dimensional image sensor 100 may be coupled to the processor 1010 via the buses or other desired communication links. As described above, the three-dimensional image sensor 100 may generate a plurality of pixel group outputs corresponding to a plurality of pixel groups by grouping a plurality of depth pixels into the plurality of pixel groups having sizes determined according to distances from the center of a FOV or from an object of interest. Accordingly, the three-dimensional image sensor 100 according to some embodiments may provide depth information with high resolution at a center region or an interest region while maintaining a SNR with less power consumption. According to some embodiments, the three-dimensional image sensor 100 and the processor 1010 may be integrated in one chip, and/or may be implemented as separate chips.

According to some embodiments, the three-dimensional image sensor 100 and/or components of the three-dimensional image sensor 100 may be packaged in various desired forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP) and/or wafer-level processed stack package (WSP), among others.

The computing system 1000 may be any computing system including the three-dimensional image sensor 100. For example, the computing system 1000 may include a digital camera, a mobile phone, a smart phone, a personal digital assistants (PDA), a portable multimedia player (PMP), a personal computer, a server computer, a workstation, a laptop computer, a digital television, a set-top box, a music player, a portable game console, and/or a navigation system among others.

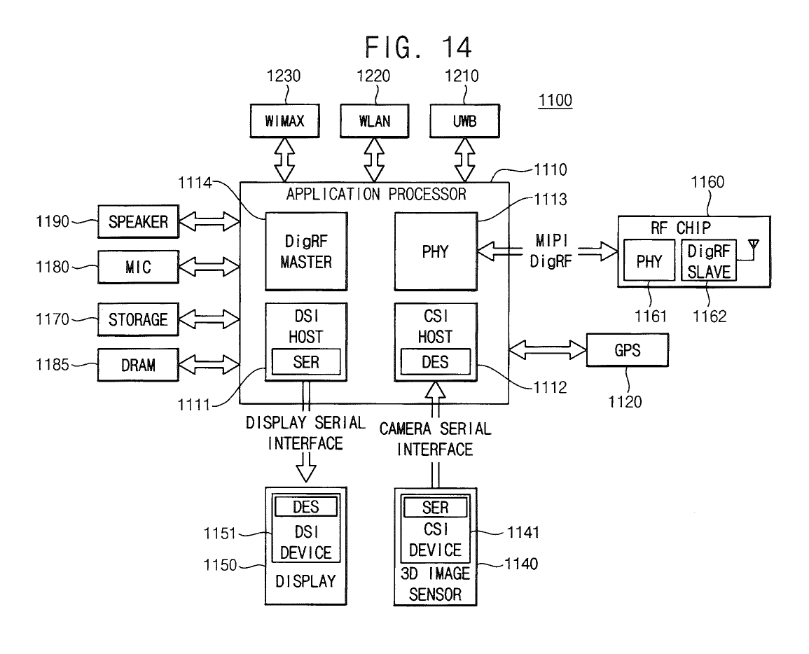

FIG. 14 is a block diagram illustrating an example of an interface used in a computing system of FIG. 13.

Referring to FIG. 14, a computing system 1100 may employ or support a MIPI interface, and may include an application processor 1110, a three-dimensional image sensor 1140 and a display device 1150. A CSI host 1112 of the application processor 1110 may perform a serial communication with a CSI device 1141 of the three-dimensional image sensor 1140 using a camera serial interface (CSI). The CSI host 1112 may include a deserializer DES, and the CSI device 1141 may include a serializer SER. A DSI host 1111 of the application processor 1110 may perform a serial communication with a DSI device 1151 of the display device 1150 using a display serial interface (DSI). The DSI host 1111 may include a serializer SER, and the DSI device 1151 may include a deserializer DES.

The computing system 1100 may further include a radio frequency (RF) chip 1160. A physical layer PHY 1113 of the application processor 1110 may perform data transfer with a physical layer PHY 1161 of the RF chip 1160 using a MIPI DigRF. The PHY 1113 of the application processor 1110 may interface (or, alternatively communicate) a DigRF MASTER 1114 for controlling the data transfer with the PHY 1161 of the RF chip 1160. The computing system 1100 may further include a global positioning system (GPS) 1120, a storage device 1170, a microphone 1180, a DRAM 1185 and/or a speaker 1190. The computing system 1100 may communicate with external devices using an ultra wideband (UWB) communication 1210, a wireless local area network (WLAN) communication 1220, and/or a worldwide interoperability for microwave access (WIMAX) communication 1230 among others. However, example embodiments are not limited to configurations or interfaces of the computing systems 1000 and 1100 illustrated in FIGS. 13 and 14.

Some embodiments may be used in any three-dimensional image sensor or any system including the three-dimensional image sensor, such as a computer, a digital camera, a three-dimensional camera, a mobile phone, a personal digital assistant (PDA), a scanner, a navigator, a video phone, a monitoring system, an auto focus system, a tracking system, a motion capture system, and/or an image stabilizing system, among others.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of operating a three-dimensional image sensor, the method comprising:
emitting modulated light to an object of interest;
detecting, at a plurality of depth pixels in the three-dimensional image sensor, reflected modulated light that is reflected from the object of interest; and
generating a plurality of pixel group outputs respectively corresponding to a plurality of pixel groups based on the detected modulated light by grouping the plurality of depth pixels into the plurality of pixel groups including a first pixel group and a second pixel group.

2. The method according to claim 1, wherein the first pixel group includes a first pixel group size that corresponds to a first quantity of the plurality of depth pixels and the second pixel group includes a second pixel group size that corresponds to a second quantity of the plurality of depth pixels, and wherein the first pixel group size is different from the second pixel group size.

3. The method according to claim 1, wherein the first pixel group has a first distance from a center of a field of view, and the second pixel group has a second distance greater than the first distance from the center of the field of view, and
wherein a quantity of the depth pixels included in the first pixel group is smaller than a quantity of the depth pixels included in the second pixel group.

4. The method according to claim 1, wherein generating the plurality of pixel group outputs comprises generating the plurality of pixel group outputs as a function of a location of the pixel group relative to a given portion of the plurality of depth pixels.

5. The method according to claim 4, wherein the given portion of the plurality of depth pixels corresponds to a center of a field of view of the three-dimensional image sensor.

6. The method according to claim 4, wherein the given portion of the plurality of depth pixels corresponds to the object of interest in a field of view of the three-dimensional image sensor.

7. The method according to claim 1, wherein a size of each of the plurality of pixel groups is determined according to a distance of each of the plurality of pixel groups from a center of a field of view.

8. The method according to claim 1, wherein a size of each of the plurality of pixel groups is determined according to a distance of each of the plurality of pixel groups from the object of interest in a field of view.

9. The method according to claim 8, wherein the first pixel group has a first distance from the object of interest in the field of view, and the second pixel group has a second distance greater than the first distance from the object of interest in the field of view, and
wherein a quantity of the depth pixels included in the first pixel group is smaller than a quantity of the depth pixels included in the second pixel group.

10. The method according to claim 1, wherein a size of each of the plurality of pixel groups is determined such that a signal-to-noise ratio of each of the plurality of pixel group outputs is higher than a target signal-to-noise ratio.

11. The method according to claim 1, wherein sizes of the plurality of pixel groups are determined such that signal-to-noise ratios of different ones of the plurality of pixel group outputs are substantially the same.

12. The method according to claim 1, wherein the first pixel group partially overlaps the second pixel group.

13. The method according to claim 12, wherein the plurality of pixel groups includes a third pixel group including at least one of the plurality of depth pixels included in the first pixel group, and a fourth pixel group including at least one of the plurality of depth pixels included in the second pixel group.

14. The method according to claim 12, wherein the plurality of depth pixels are grouped into the plurality of pixel groups such that a quantity of the plurality of pixel groups is substantially the same as a quantity of the plurality of depth pixels.

15. A method of operating a three-dimensional image sensor including a light source module and a plurality of depth pixels, the light source module including a light source and a lens, the method comprising:
emitting first modulated light to an object of interest using the light source module;
detecting the first modulated light that is reflected from the object of interest using the plurality of depth pixels;
obtaining position information of the object of interest based on the detected first modulated light;
adjusting a relative position of the light source to the lens based on the position information;
emitting second modulated light to the object of interest using the light source module in which the relative position of the light source is adjusted;
detecting the second modulated light that is reflected from the object of interest using the plurality of depth pixels; and
generating a plurality of pixel group outputs respectively corresponding to a plurality of pixel groups based on the detected second modulated light by grouping the plurality of depth pixels into the plurality of pixel groups including a first pixel group and a second pixel group that have different sizes from each other.

16. The method according to claim 15, wherein the relative position of the light source to the lens is adjusted such that the second modulated light is focused on the object of interest, and
wherein a size of each of the plurality of pixel groups is determined according to a distance of each of the plurality of pixel groups from the object of interest in a field of view.

17. The method according to claim 16, wherein the first pixel group has a first distance from the object of interest in the field of view, and the second pixel group has a second distance greater than the first distance from the object of interest in the field of view, and
wherein a quantity of the depth pixels included in the first pixel group is smaller than a quantity of the depth pixels included in the second pixel group.

18. The method according to claim 15, wherein the position information includes at least one of a distance of the object of interest from the three-dimensional image sensor, a horizontal position of the object of interest in a field of view, a vertical position of the object of interest in the field of view, and a size of the object of interest in the field of view.

19. The method according to claim 15, wherein adjusting the relative position of the light source to the lens comprises:
adjusting at least one of an interval between the light source and the lens, a horizontal position of the light source, a horizontal position of the lens, a vertical position of the light source, and a vertical position of the lens.
